(19) United States
(12) Patent Application Publication
(10) Pub. No.: US 2014/0379351 A1
(43) Pub. Date: Dec. 25, 2014

(54) SPEECH DETECTION BASED UPON FACIAL MOVEMENTS

(71) Applicant: Sundeep Raniwala, Folsom, CA (US)

(72) Inventor: Sundeep Raniwala, Folsom, CA (US)

(21) Appl. No.: 14/127,047

(22) PCT Filed: Jun. 24, 2013
(86) PCT No.: PCT/US2013/047321

§ 371 Date: Dec. 17, 2013

(51) Int. Cl. G10L 25/48; G10L 15/25

(52) U.S. Cl. CPC G10L 25/48; G10L 15/25
USPC 704/270

(57) ABSTRACT

Apparatus, computer-readable storage medium, and method associated with speech communication, including determining whether a user is speaking, are described. In embodiments, a computing device may include a camera, a microphone, and a speech sensing module. The speech sensing module may be configured to determine whether a user of the computing device is speaking. This determination may be based upon mouth movements of the user detected through images captured by the camera. As a result of the determination, the microphone may be muted or unmuted. Other embodiments may be described and/or claimed.

### TECHNICAL FIELD

Embodiments of the present disclosure are related to the field of data processing, and in particular, to the field of perceptual computing.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

When utilizing a microphone on a computer system ambient noise can be an issue. This is especially evident in the area of online conferencing. Currently when a user is conferencing with one or more other users through a computing device the user has to manually mute or unmute the user's own microphone in order to limit the amount of background noise transmitted through to the other users. This may be especially burdensome when the user is in an area with high ambient noise, such as a coffee shop or at home with children in the background. Manually muting and unmuting the microphone can be tedious, especially when the user needs to speak frequently, which may make it more likely that a user would forget to mute or unmute the user's microphone. In addition, there may be instances where a user in a video conference has turned away from the screen or stepped away from the video conference for a moment. In these instances, a user may not even be present to mute the microphone and the other participants may be forced to deal with ambient noise until the user's attention is drawn back to the conference or the user returns.

### BRIEF DESCRIPTION OF THE DRAWINGS

FIG. 1 depicts an illustrative environment in which some embodiments of the present disclosure may be utilized.

FIG. 2 depicts an illustrative user interface according to some embodiments of the present disclosure.

FIG. 3 depicts an illustrative computing device capable of implementing some embodiments of the present disclosure.

FIG. 4 depicts an illustrative process flow according to some embodiments of the present disclosure.

FIG. 5 depicts an illustrative representation of a computing device in which some embodiments of the present disclosure may be implemented.

### DETAILED DESCRIPTION OF ILLUSTRATIVE EMBODIMENTS

A method, storage medium, and a computing device capable of detecting whether a user is speaking, are described. In embodiments, the computing device may include a camera, a microphone, and a speech sensing module. The speech sensing module may be configured to detect mouth movements of the user through images captured by the camera and, based upon those movements, may determine whether the user is speaking or not. Speech sensing module may be configured to track additional non-mouth facial movements, or non-facial motion, such as hand motion, of the user, to integrate into the determination of whether the user is speaking.

In the following detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

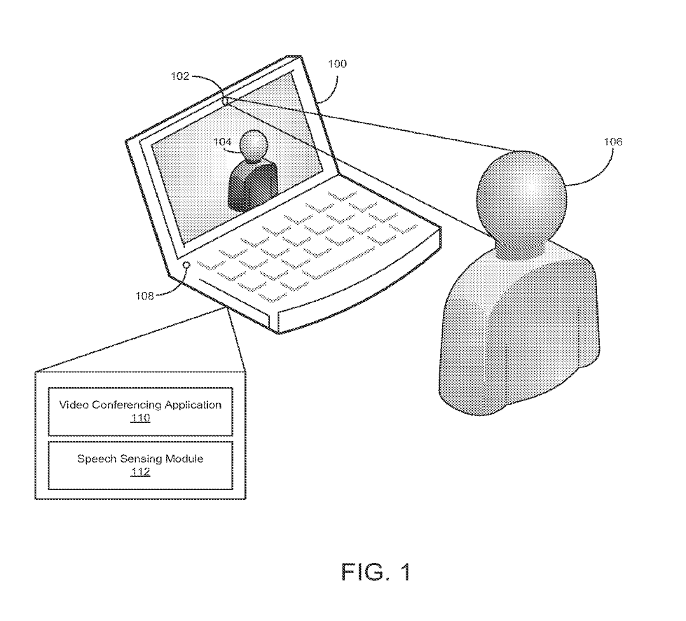

FIG. 1 depicts an illustrative environment in which some embodiments of the present disclosure may be utilized. As depicted, a computing device 100, e.g., a laptop, may be configured with hardware and/or software components to facilitate a first user 106 to engage in an online meeting with a second user 104, typically, remotely located from the first user 106. In embodiments, computing device 100 may have an integrated camera 102 configured to capture and generate a number of images of user 106 for a video conferencing application 110 operating on computing device 100. Computing device 100 may also include microphone 108 configured to accept speech input from user 106. As will be appreciated by those skilled in the art, speech input will typically be accepted with ambient noises. In embodiments, computing device 100 may include a speech sensing module 112 configured to track mouth movements, non-mouth facial movements, and/or non-facial movements, such as hand and/or arm movements, of user 106, using images captured by camera 102. The non-mouth facial movements may include, but are not limited to, movements of the eyes, eyebrows, and ears. The hand and/or arm movements may include co-speech gestures, or gestures co-occurring with speech. Any movements indicative of speech are contemplated by this disclosure.

The various movements may be analyzed by speech sensing module 112 to determine whether the first user 106 is currently speaking. The result of that determination may be that the first user 106 is not currently speaking and, consequently, microphone 108 on computing device 100 may be muted. Once the first user 106 begins to speak, as determined based on the various movements, the microphone may be unmuted. These and other aspects will be described in more detail below.

It will be appreciated that, while computing device 100 is depicted as a laptop in FIG. 1, computing device 100 may be any kind of computing device including, but not limited to, smart phones, tablets, desktop computers, computing kiosks, gaming consoles, etc. Also, the present disclosure may be practiced on computing devices without cameras, e.g., computing devices with interfaces configured to receive an external camera or output from an external camera.

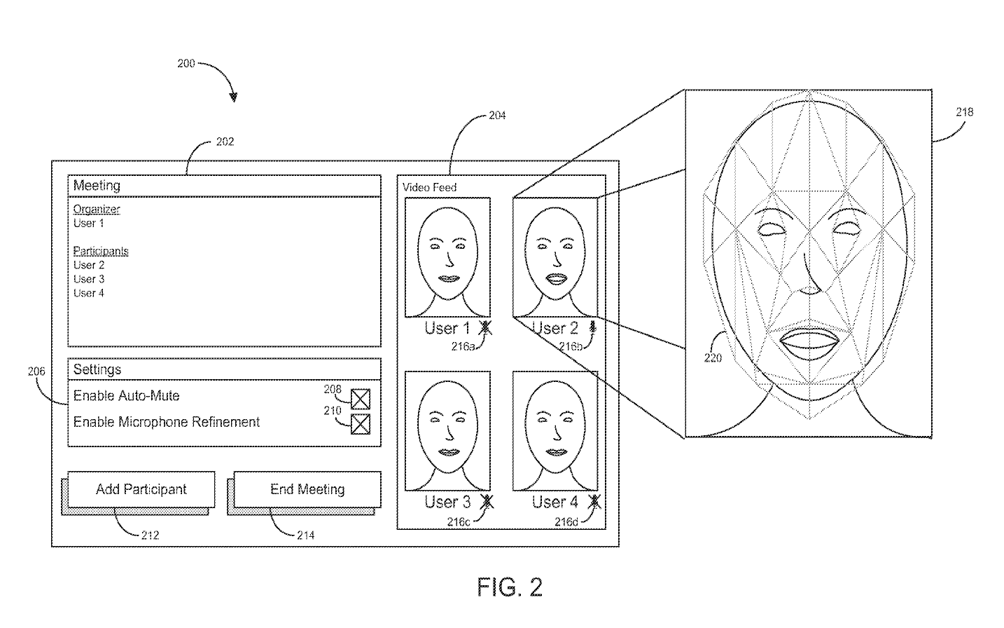

FIG. 2 depicts an illustrative user interface 200 according to some embodiments of the present disclosure. User interface 200 may be configured to depict a screen shot of a sample meeting application with an ongoing online meeting between Users 1-4, in which embodiments of the present disclosure may be implemented. As depicted here, the user interface may include a meeting details box 202 which may distinguish between the organizer and the participants of the current meeting. A video feed 204 displays live video feed from the users involved in the meeting along with microphones 216a-216d associated with the users indicating the individual user's muted status. For example, here, the ‘X’ over the microphone symbol indicates the user is currently muted and those without the ‘X’ are not. As depicted here, User 2 may be the only user currently speaking and may therefore be the only user not currently muted.

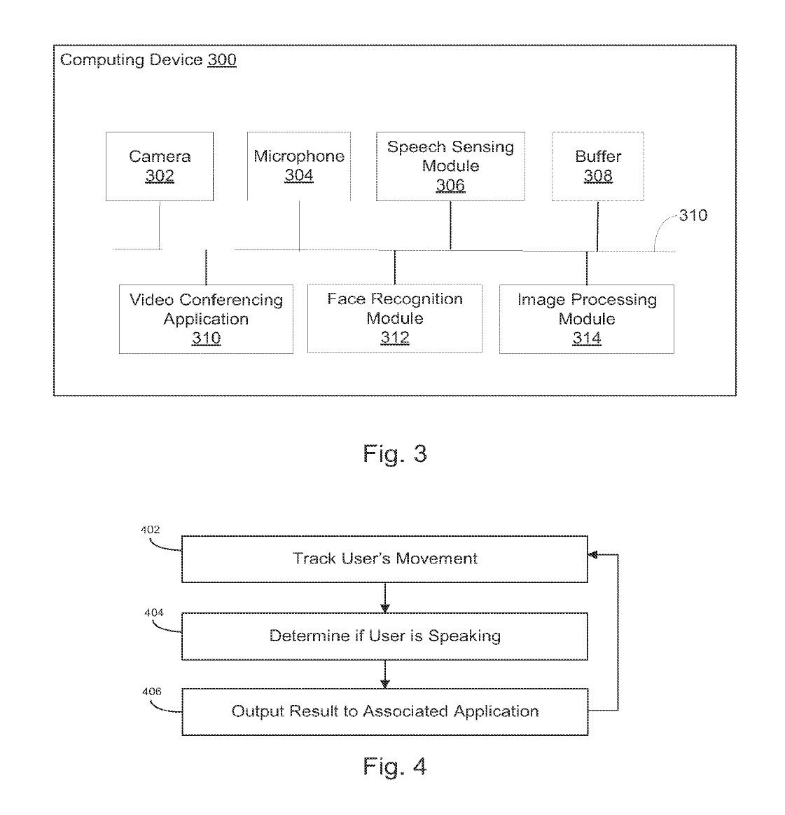

User interface 200 may also include a settings box 206 which may enable the individual users and/or the meeting organizer to enable and disable the auto-mute functionality of the meeting application by checking or unchecking box 208. In some embodiments, the user may be able to refine the auto-mute functionality by checking the microphone refinement checkbox 210. The microphone refinement is discussed in further below in reference to FIG. 3. User interface 200 may also give the participants and/or the meeting the organizer the ability to add a participant to the meeting or end the meeting by clicking the add participant button 212 or the end meeting button 214, respectively.

An illustrative facial tracking of User 2 is depicted in box 218 and may or may not be displayed to the user of user interface 200. This facial tracking may utilize wireframe 220 to track any number of facial indicators to determine if the user is currently speaking. These facial indicators may include, but are not limited to, a distance between an upper and lower lip, movements of the corners of the mouth, a shape of the mouth, movements of the jawline, and/or movements of the eyes and eyebrows. The utilization of these facial indicators in determining if a user is currently speaking are discussed further in reference to FIG. 3, below. While not depicted here, the wireframe may also be extended to track movements of the arms and/or hands of the user, as many users may utilize the arms and/or hands to gesture while speaking.

While, for ease of understanding, box 218 is illustrated as substantially corresponding to the image displayed for User 2 from the video feed, with the face of User 2 substantially occupying the displayed image in video feed 204 and box 218, in embodiments where box 218 is displayed to the user, box 218 may merely be a region of interest from the images employed to display the image for User 2 from video feed 204, which may be less than an entirety of the images.

Likewise, for ease of understanding, box 218 is illustrated with the wireframe 220 covering the face of User 2, in embodiments, wireframe 220 may cover more than the face, including other parts of the body, such as the hands of the user, as many users often speak in animated manners with movements of their hands.

Further, the determining of whether the user is speaking may be performed as part of a face recognition process to determine an identity of the user.

FIG. 3 depicts an illustrative computing device capable of implementing some embodiments of the present disclosure. Computing device 300 may include camera 302, microphone 304, speech sensing module 306, video conferencing application 310, and may optionally include buffer 308, face recognition module 312, and image processing module 314. Camera 302, microphone 304, speech sensing module 306, buffer 308, video conferencing application 310, face recognition module 312 and image processing module 314, may all be interconnected by bus 310, which may comprise one or more buses. In embodiments with multiple buses, the buses may be bridged. Camera 302, as described earlier, may be configured to capture a number of images of a user of computing device 300. Furthermore, microphone 304, as described earlier, may be configured to accept speech input to the computing device 300, which often include ambient noises.

Speech sensing module 306 may receive the images from camera 302 and may utilize these images in determining whether a user is speaking. Image processing module may process the images. In embodiments, speech sensing module 306 may be configured to analyze the user's movements, e.g., mouth movements, by applying a wireframe, such as wireframe 220 of FIG. 2, to a region of interest in the images. In some embodiments, it may not be necessary to apply a full wireframe and instead speech sensing module 306 may utilize facial landmark points, such as the inside and outside of each eye, the nose, and/or the corners of the mouth, to track facial movements, in particular mouth movements.

In embodiments, speech sensing module 306 may be configured to determine if a user is speaking based upon an analysis of distance between the user's upper and lower lip. If the distance between the upper and lower lips changes at a predetermined rate, or the rate of change surpasses a predetermined threshold, then the speech sensing module may determine the user is speaking. In the alternative, if the changes drop below the predetermined rate or predetermined threshold, then the speech sensing module may determine that the user is not speaking. In other embodiments, a similar analysis may be applied to movements of the corners of the user's mouth and/or the user's jaw where a distance and/or rate of movement may be used to determine if the user is speaking.

In some embodiments, the shape of the mouth may be tracked to determine if a user is speaking. If the shape of a user's mouth changes at a specific rate or threshold, then the speech sensing module may determine the user is speaking, while changes below the specific rate or threshold may cause the speech sensing module to determine that the user is not speaking. In some embodiments, the shape of a user's mouth may be tracked for predefined patterns of movements. These predefined patterns of movements may include successive changes to a shape of the user's mouth and may be indicative of a user talking. In these embodiments, speech sensing module 306 may include a database or access a database, locally or remotely, that may contain the predefined patterns with which to compare the pattern of movement of the user's mouth. If the pattern of movement matches a predefined pattern then speech sensing module 306 may determine that the user is speaking and may determine that the user is not speaking if the pattern of movements does not match a predefined pattern.

In some embodiments, it may be desirable to refine the detection of when a user is speaking based upon non-mouth movements, such as movement of the eyebrows or ears for patterns that seem to suggest the user is speaking. In embodiments, the images may include hand and/or arm movements of the user and these movements may also be tracked. This tracking may aid speech sensing module 306 in determining whether the user is talking as many users make specific gestures and/or movements of their hands and arms when talking. In some embodiments, an audio feed from the microphone may aid in refining the speech detection. For example, the audio feed may be analyzed to determine if it contains a frequency or range of frequencies generated by human speech. This may enable the speech sensing module to differentiate between a user's facial movement not related to speech and those that are. For example, if a user is eating, the facial tracking may indicate that the user is talking, but the audio feed may allow speech sensing module 306 to determine that the user is not actually talking because there are no frequencies associated with a user's speech. It will be appreciated that this could be even further refined by sampling the user's voice to determine the frequency ranges associated with the user speaking.

It will be appreciated that each of the above described embodiments may be integrated together in any combination. It will also be appreciated that the sensitivity of the speech sensing module may be adjusted by adjusting any of the previously discussed predefined rates and/or thresholds.

In some embodiments, speech sensing module 306 may automatically mute an audio feed from microphone 304 if speech sensing module 306 detects that the user is not speaking and may unmute the audio feed if it detects that the user is speaking. In other embodiments, speech sensing module 306 may act as an application programming interface (API) that merely provides the result of its determination concerning whether the user is speaking to other applications that may be executing on computing device 300 or on a remote server. An example application executing on computing device 300 may be video conferencing application 310. These other applications may utilize the results from speech sensing module 306 in determining an action to perform, e.g., automatically muting or unmuting microphone 304.

In some embodiments, computing device 300 may include buffer 308. Buffer 308 may be utilized to store at least a most recent portion of audio feed from microphone 304. When a user begins speaking there may be a small delay before speech sensing module 306 detects that the user has begun to speak. Buffer 308 may be utilized to store the audio feed in order to ensure no audio is lost while speech sensing module 306 is processing.

Facial recognition module 312 may be configured to analyze the images output by camera 302 to determine an identity of the user.

In embodiments, facial recognition module 312 and speech sensing module 306 may be tightly coupled or closely integrated as a single component to enable speech sensing to be performed integrally with face recognition.

FIG. 4 depicts an illustrative process flow according to some embodiments of the present disclosure. The process may begin at block 402 where the tracking of the user's movement begins. As discussed above in reference to FIG. 3, this may include tracking of the user's mouth, including the user's lips, jawline, the corners of the user's mouth, etc. In some embodiments, this may also include tracking non-mouth facial movements, such as eyebrow or ear movements, or non-facial movements such as movements of the hand and/or arms, for example. In some embodiments, this may include tracking of an audio feed from a microphone to detect specific frequencies, such as frequencies associated with the user's speech. This tracking may be accomplished, at least in part, by utilizing tools such as the Intel® Perceptual Computing Software Development Kit (SDK), for example.

In block 404 the results of the tracking may be utilized to determine if the user is speaking. The determination of whether the user is speaking may be based upon a combination of any of the tracking discussed in reference to FIG. 3 above. Once a determination is made, the result of the determination may be output for use by an associated application. The associated application may be any application capable of utilizing the results, such as, but not limited to, video-conferencing applications, speech recognition applications, dictation applications, etc.

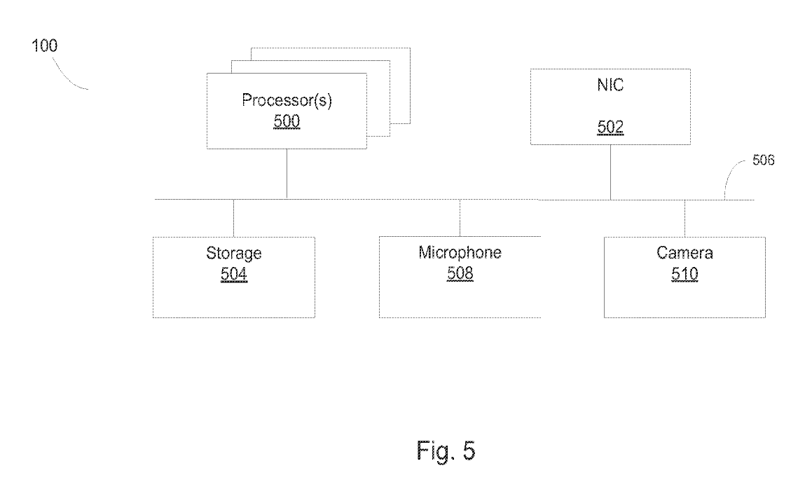

FIG. 5 depicts an illustrative configuration of computing device 100 according to some embodiments of the disclosure. Computing device 100 may comprise processor(s) 500, network interface card (N IC) 502, storage 504, microphone 508, and camera 510. Processor(s) 500, NIC 502, storage 504, microphone 508, and camera 510 may all be coupled together utilizing system bus 506.

Processor(s) 500 may, in some embodiments, be a single processor or, in other embodiments, may be comprised of multiple processors. In some embodiments the multiple processors may be of the same type, i.e. homogeneous, or they may be of differing types, i.e. heterogenous and may include any type of single or multi-core processors. This disclosure is equally applicable regardless of type and/or number of processors.

In embodiments, NIC 502 may be used by computing device 100 to access a network. In embodiments, NIC 502 may be used to access a wired or wireless network; this disclosure is equally applicable. NIC 502 may also be referred to herein as a network adapter, LAN adapter, or wireless NIC which may be considered synonymous for purposes of this disclosure, unless the context clearly indicates otherwise; and thus, the terms may be used interchangeably.

In embodiments, storage 504 may be any type of computer-readable storage medium or any combination of differing types of computer-readable storage media. For example, in embodiments, storage 504 may include, but is not limited to, a solid state drive (SSD), a magnetic or optical disk hard drive, volatile or non-volatile, dynamic or static random access memory, flash memory, or any multiple or combination thereof. In embodiments, storage 504 may store instructions which, when executed by processor(s) 500, cause computing device 100 to perform one or more operations of the process described in reference to FIG. 4, above, or any other processes described herein. Microphone 508 and camera 510 may be utilized, as discussed above, for tracking sounds and/or movements produced by a user of computing device 100.

Embodiments of the disclosure can take the form of an entirely hardware embodiment, an entirely software embodiment or an embodiment containing both hardware and software elements. In various embodiments, software, may include, but is not limited to, firmware, resident software, microcode, and the like. Furthermore, the disclosure can take the form of a computer program product accessible from a computer-usable or computer-readable medium providing program code for use by or in connection with a computer or any instruction execution system.

For the purposes of this description, a computer-usable or computer-readable medium can be any apparatus or medium that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the disclosure. In particular, while for ease of understanding, the Specification has mainly described the present disclosure in the context of analyzing images of a local user to determine whether the local user is speaking, and mute/unmute a local audio input, the present disclosure is not so limited. In embodiments, the present disclosure may also be practiced to locally analyze images of a remote user to determine whether the remote user is speaking, and include/exclude the audio feed of the remote user from the audio mix to generate the local audio output. This application is intended to cover any adaptations or variations of the embodiments discussed herein. Therefore, it is manifestly intended that the embodiments of the disclosure be limited only by the claims and the equivalents thereof.

### EXAMPLES

Example 1 is a computing device for speech communication, the computing device including: a processor; an image processing module, coupled to the processor, configured to cause the processor to process captured images; and a speech sensing module coupled to the processor, The speech sensing module is configured to cause the processor to: determine whether the user of the computing device is speaking, based, at least in part, upon mouth movements of the user detected through the processed images, wherein the mouth movements include at least a selected one of a rate of movements or a pattern of movements; and output a result of the determination to enable a setting of a component or a peripheral of the computing device to be changed, based at least in part on the result of the determination.

Example 2 may include the subject matter of Example 1, wherein a pattern of movement comprises successive changes to a shape of the mouth of the user detected through the images captured by the camera.

Example 3 may include the subject matter of Example 1, wherein determine whether the user is speaking is further based on non-mouth facial movements or hand movements of the user detected through the images.

Example 4 may include the subject matter of Example 1, wherein the speech sensing module is further configured to cause the processor to monitor audio signals output by a microphone of the computing device, and further base the determination of whether the user of the computing device on a result of the monitoring.

Example 5 may include the subject matter of Example 4, wherein monitor audio signals comprises monitor for audio signals within a specific frequency range and the specific frequency range is associated with speaking.

Example 6 may include the subject matter of any one of Examples 1-5, wherein the computing device further comprises: a video conferencing application operatively coupled with the speech sensing module, and configured to mute or unmute a microphone of the computing device, based at least in part on the result of the determination output by the speech sensing module.

Example 7 may include the subject matter of Example 6, wherein the computing device further comprises: a camera coupled with the image processing module, and configured to capture the images; and the microphone, configured to accept speech inputs.

Example 8 may include the subject matter of any one of Examples 1-5, wherein the computing device further comprises a memory buffer configured to store a most recent audio stream from a microphone of the computing device, and the speech sensing module is further configured to recover audio lost from the most recent audio stream while determining whether the user is speaking.

Example 9 may include the subject matter of Examples 1-5, further comprising a facial recognition module configured to recognize the user based on the images; wherein the facial recognition module comprises the speech sensing module.

Example 10 is a computer-implemented method for speech communication, the method comprising: processing, by a computing device, a plurality of images; and determining, by the computing device, whether a user of the computing device, is speaking based, at least in part, on mouth movements of the user detected through the processed images, wherein the mouth movements include at least a selected one of a rate of movements or a pattern of movements.

Example 11 may include the subject matter of Example 10, wherein a pattern of movements comprises successive changes to a shape of the mouth of the user.

Example 12 may include the subject matter of Example 10, further comprising tracking non-mouth facial movements of the user, wherein determining whether the user is speaking is further based on the tracking of the non-mouth facial movements.

Example 13 may include the subject matter of Example 10, further comprising monitoring audio signals output by a microphone of the computing device, and wherein determining whether the user is speaking is further based upon a result of the monitoring.

Example 14 may include the subject matter of Example 13, wherein monitoring audio signals further includes monitoring audio signals within a specific frequency range associated with speaking.

Example 15 may include the subject matter of Example 10, further comprising facilitating a video conference with one or more remote conferees for the user, and muting or unmuting a microphone of the computing device based at least in part on a result of the determining.

Example 16 may include the subject matter of Example 10, further comprising storing, by the computing device, a most recent audio stream from the microphone in a memory buffer of the computing device.

Example 17 may include the subject matter of Example 16, further comprising recovering audio lost from the most recent audio stream while determining whether the user is speaking.

Example 18 may include the subject matter of Example 10, further comprising analyzing, by the computing device, a face in the images to determine an identity of the user, wherein the determining is performed in conjunction with the facial analysis.

Example 19 is a computer readable storage medium containing instructions, which, when executed by a processor, configure the processor to perform the method of any one of Examples 10-18.

Example 20 is a computing device comprising means for performing the method of any one of Examples 10-18.

Example 21 is a computing device for speech communication, the computing device comprising: a camera; a microphone; a video conferencing application operatively coupled with the camera and the microphone; a facial recognition module operatively coupled with the video conferencing application, and configured to recognize an identity of a user of video conferencing application and the computing device. The facial recognition module is further configured to determine whether the user is speaking based, at least in part, upon mouth movements of the user detected through images captured by the camera; and wherein the video conferencing application is further configured to mute or unmute the microphone based upon a result of the determining.

Example 22 may include the subject matter of Example 21, wherein the facial recognition module is further configured to determine whether the user is speaking, based on non-mouth facial movements or hand movements detected through the images, or audio signals output from the microphone.

Example 23 may include the subject matter of Example 22, wherein the mouth movements include at least a selected one of a rate of movements or a pattern of movements.

Example 24 is a computer implemented method for speech communication, the method comprising: capturing a plurality of images by a computing device; facilitating a video conference by the computing device, using the images and the speech input; determining an identity of a user of the video conference of the computing device through facial recognition based on the images, wherein determining further comprises determining whether the user is speaking based, at least in part, upon mouth movements of the user detected through the images; and muting or unmuting, by the computing device, speech input for the video conference.

Example 25 may include the subject matter of Example 24, wherein determining whether the user is speaking, is further based on the non-mouth facial movements or hand movements detected through the images, or audio signals output by a microphone of the computing device.

1-25. (canceled)

26. A computer readable storage medium containing instructions, which, when executed by a processor of a computing device, configure the computing device to:
process a plurality of images; and
determine whether a user of the computing device, is speaking based, at least in part, on mouth movements of the user detected through the processed images, wherein the mouth movements include at least a selected one of a rate of movements or a pattern of movements.

27. The computer readable storage medium of claim 26, wherein a pattern of movements comprises successive changes to a shape of the mouth of the user.

28. The computer readable storage medium of claim 26, wherein the instructions, when executed by the processor, further configure the computing device to track non-mouth facial movements of the user, and wherein to determine whether the user is speaking is further based on the tracking of the non-mouth facial movements.

29. The computer readable storage medium of claim 26, wherein the instructions, when executed by the processor, further configure the computing device to monitor audio signals output by a microphone of the computing device, and wherein to determine whether the user is speaking is further based upon a result of the monitoring.

30. The computer readable storage medium of claim 29, wherein the instructions to monitor audio signals further configure the computing device to monitor audio signals within a frequency range associated with speaking.

31. The computer readable storage medium of claim 26, wherein the instructions, when executed by the processor, further configure the computing device to facilitate a video conference with one or more remote conferees for the user, and mute or unmute a microphone of the computing device based at least in part on a result of the determination.

32. The computer readable storage medium of claim 26, wherein the instructions, when executed by the processor, further configure the computing device to store a most recent audio stream from the microphone in a memory buffer of the computing device.

33. The computer readable storage medium of claim 32, wherein the instructions, when executed by the processor, further configure the computing device to recover audio lost from the most recent audio stream while determining whether the user is speaking.

34. The computer readable storage medium of claim 26, wherein the instructions, when executed by the processor, further configure the computing device to analyze a face in the images to determine an identity of the user, wherein to determine is performed in conjunction with the facial analysis.

35. A computing device for speech communication, the computing device comprising:
one or more processors;
an image processing module, coupled to the processor, configured to cause the processor to process captured images; and
a speech sensing module coupled to the processor, wherein the speech sensing module is configured to cause the one or more processors to:
determine whether the user of the computing device is speaking, based, at least in part, upon mouth movements of the user detected through the processed images, wherein the mouth movements include at least a selected one of a rate of movements or a pattern of movements; and
output a result of the determination to enable a setting of a component or a peripheral of the computing device to be changed, based at least in part on the result of the determination.

36. The computing device of claim 35, wherein a pattern of movement comprises successive changes to a shape of the mouth of the user detected through the images captured by the camera.

37. The computing device of claim 35, wherein to determine whether the user is speaking is further based on non-mouth facial movements or hand movements of the user detected through the images.

38. The computing device of claim 35, wherein the speech sensing module is further configured to cause the processor to monitor audio signals output by a microphone of the computing device, and further base the determination of whether the user of the computing device is speaking based on a result of the monitoring.

39. The computing device of claim 38, wherein to monitor audio signals comprises to monitor for audio signals within a frequency range associated with speaking.

40. The computing device of claim 35, wherein the computing device further comprises:
a video conferencing application operatively coupled with the speech sensing module, and configured to mute or unmute a microphone of the computing device, based at least in part on the result of the determination output by the speech sensing module.

41. The computing device of claim 40, wherein the computing device further comprises:
a camera coupled with the image processing module, and configured to capture the images; and
the microphone, configured to accept speech input.

42. The computing device of claim 35, wherein the computing device further comprises a memory buffer configured to store a most recent audio stream from a microphone of the computing device, and the speech sensing module is further configured to recover audio lost from the most recent audio stream while determining whether the user is speaking.

43. The computing device of claim 35, further comprising a facial recognition module configured to recognize the user based on the images; wherein the facial recognition module comprises the speech sensing module.

44. A computer-implemented method for speech communication, the method comprising:
processing, by a computing device, a plurality of images; and
determining, by the computing device, whether a user of the computing device, is speaking based, at least in part, on mouth movements of the user detected through the processed images, wherein the mouth movements include at least a selected one of a rate of movements or a pattern of movements.

45. The computer-implemented method of claim 44, wherein a pattern of movements comprises successive changes to a shape of the mouth of the user.

46. The computer-implemented method of claim 44, further comprising tracking non-mouth facial movements of the user, wherein determining whether the user is speaking is further based on the tracking of the non-mouth facial movements.

47. The computer-implemented method of claim 44, further comprising monitoring audio signals output by a microphone of the computing device, and wherein determining whether the user is speaking is further based upon a result of the monitoring.

48. A computing device for speech communication, the computing device comprising:
a camera;
a microphone;
a video conferencing application operatively coupled with the camera and the microphone;
a facial recognition module operatively coupled with the video conferencing application, and configured to recognize an identity of a user of video conferencing application and the computing device;
wherein the facial recognition module is further configured to determine whether the user is speaking based, at least in part, upon mouth movements of the user detected through images captured by the camera; and
wherein the video conferencing application is further configured to mute or unmute the microphone based upon a result of the determining.

49. The computing device of claim 48, wherein the facial recognition module is further configured to determine whether the user is speaking, based on non-mouth facial movements or hand movements detected through the images, or audio signals output from the microphone.

50. The computing device of claim 49, wherein the mouth movements include at least a selected one of a rate of movements or a pattern of movements.
